(19) United States
(12) Patent Application Publication
(10) Pub. No.: US 2023/0186113 A1
(43) Pub. Date: Jun. 15, 2023

(54) MACHINE LEARNING-BASED FUTURE INNOVATION PREDICTION METHOD AND SYSTEM THEREFOR

(71) Applicant: KOREA ADVANCED INSTITUTE OF SCIENCE AND TECHNOLOGY, Yuseong-Gu Daejeon (KR)

(72) Inventors: Wonjoon Kim, Yuseong-Gu Daejeon (KR); JongHwan SUH, Yuseong-Gu Daejeon (KR)

(21) Appl. No.: 17/905,316

(22) PCT Filed: Jan. 18, 2021
(86) PCT No.: PCT/KR2021/000664

§ 371 Date: Feb. 1, 2023

(30) Foreign Application Priority Data
Mar. 3, 2020 (KR) 10-2020-0026368
Aug. 21, 2020 (KR) 10-2020-0105512

(51) Int. Cl. G06N 5/022; G06Q 50/18

(52) U.S. Cl. CPC G06N 5/022; G06Q 50/184

(57) ABSTRACT

Disclosed are a machine learning-based future innovation prediction method and a system therefor. The machine learning-based future innovation prediction method according to an embodiment of the present invention may comprise the steps of: collecting patent data for each of predetermined companies, data relating to research and development of each of the companies, and performance data during a predetermined period; classifying feature sets according to respective features by using each piece of the collected data; and predicting future innovation of a corresponding company on the basis of machine learning using the classified feature sets as inputs, wherein the collecting step includes collecting patent data including the number of claims, an assignee, the number of assignees, an inventor, the number of inventors, the number of backward citations, and the number of forward citations for each of registered patents during a predetermined period with respect to each of the companies.

### TECHNICAL FIELD

The present invention relates to a machine learning-based future innovation prediction technology, and more specifically, a method for predicting future innovation in terms of companies based on big data and predictive analysis using a machine learning technique that explores the usefulness of patent indicators, and a system therefor.

### BACKGROUND ART

To achieve success and survival, companies must explore new sources of competitive advantage while focusing on risk taking, discovery, experimentation, discovery and innovation. The innovation can contribute to these efforts because the innovation provides unprecedented and significant improvements to products processes, or services. Therefore, the innovation often results in the collapse of current firms and the emergence of new markets and firms.

Innovative development is unpredictable and sporadic. The reason for this is that innovation is associated with a high degree of uncertainty and risk from a technology and market perspective. Companies cannot predict when researchers will create an innovation or when an innovation will turn into an actual marketable innovation in the development phase, and even know the probability and extent of a product's success in the adoption phase. The unpredictability of these innovations makes it difficult for companies to manage R&D as well as for investors to manage their investment portfolios.

Therefore, the ability of companies to predict innovation in advance is important and valuable to companies that manage R&D and investors who manage their investment portfolios more effectively. In other words, companies can effectively allocate resources to radical innovations and enhance their competitive advantage by predicting future innovations. For example, pharmaceutical companies can increase their competitiveness by allocating resources to clinical trials of more innovative new drugs. From an equity investment perspective, predicting future innovations enables individual investors to maximize their return on investment by focusing on companies that are more likely to adopt innovations, which in turn will allocate resources more efficiently in the market. In other words, from both a technology and market perspective, predicting future innovations has a significant impact on companies and investors.

Nevertheless, not many approaches have been proposed for predicting innovation. Most previous studies have focused on identifying the features and dynamics of innovation, as well as the factors that influence innovation at various levels, such as individual, corporate, and industry levels, over several decades. No prior work has attempted to predict future innovations, especially at the company level, because of the limitations of previous statistical methods, which are difficult to handle with large, noisy, and complex data.

At the same time, information systems that support business information and analytics can help companies access and analyze big data from a variety of sources, thereby providing insight into potential opportunities, competitive advantage and forecasting for better decision-making. In particular, with the improvement of computer power and the development of artificial intelligence, machine learning techniques can emerge as a powerful alternative of statistical methods for prediction. Machine learning techniques learn a model from existing data and make predictions on new data using the model. The machine learning techniques make predictions in a variety of fields, including biomedical informatics, computer vision, and civil engineering using large, noisy, and complex data. However, there have been no previous studies in which both big data and machine learning have applied to predict future innovations in companies.

### DETAILED DESCRIPTION OF THE INVENTION

### Technical Problem

Embodiments of the present invention provide a method and system for predicting future innovation at the company level based on big data and predictive analysis using machine learning techniques that explore the usefulness of company financial data, newspaper articles, social media data and patent indicators.

### Technical Solution

According to an embodiment of the present invention, a machine learning-based future innovation prediction method includes collecting patent data for each of predetermined companies, data relating to research and development of each of the companies, and performance data during a predetermined period, performing classification into feature sets according to respective features by using each piece of the collected data, and predicting future innovation of a corresponding company on the basis of machine learning using the classified feature sets as inputs.

The collecting of the data may include collecting patent data including a number of claims, an assignee, a number of assignees, an inventor, a number of inventors, a number of backward citations, and a number of forward citations for each of registered patents during the predetermined period with respect to each of the companies.

The collecting of the data may include collecting data for each of the companies including company finances for the predetermined period, pass of clinical trials, data approved by the U.S. Food and Drug Administration (FDA), technical and commercial success data of technology, and launch/certification/authorization data of new products/new services, as performance data.

The predicting of the future innovation may include predicting the performance of a corresponding company based on machine learning using logistic regression (Logit), naive Bayes (NB), neural network (NN), support vector machine (SVM) and deep belief network (DBN).

The performing classification may include performing classification into feature sets including internal and external collaboration structures using patent indicators using the patent data and the data relating to research and development and structural relationships between patents based on analysis of patent content.

According to an embodiment of the present invention, a machine learning-based future innovation prediction system includes a collection unit configured to collecting patent data for each of predetermined companies, data relating to research and development of each of the companies, and performance data during a predetermined period, a classification unit configured to perform classification into feature sets according to respective features by using each piece of the collected data, and a prediction unit configured to predict future innovation of a corresponding company on the basis of machine learning using the classified feature sets as inputs.

The collection unit may collect patent data including a number of claims, an assignee, a number of assignees, an inventor, a number of inventors, a number of backward citations, and a number of forward citations for each of registered patents during the predetermined period with respect to each of the companies.

The collection unit may collect data for each of the companies including company finances for the predetermined period, pass of clinical trials, data approved by the U.S. Food and Drug Administration (FDA), technical and commercial success data of technology, and launch/certification/authorization data of new products/new services, as performance data.

The prediction unit may predict the performance of a corresponding company based on machine learning using logistic regression (Logit), naive Bayes (NB), neural network (NN), support vector machine (SVM) and deep belief network (DBN).

The classification unit may perform classification into feature sets including internal and external collaboration structures using patent indicators using the patent data and the data relating to research and development and structural relationships between patents based on analysis of patent content.

### Advantageous Effects of the Invention

According to embodiments of the present invention, it is possible to predict future innovation at the company level based on big data and predictive analysis using machine learning techniques to explore the usefulness of patent indicators.

### DESCRIPTION OF THE DRAWINGS

FIG. 1 illustrates an operational flowchart a machine learning-based future innovation prediction method according to an embodiment of the present invention.

FIG. 2A, 2B, 2C and 2D illustrates a framework for a machine learning-based future innovation prediction method according to an embodiment of the present invention.

FIG. 3 illustrates a configuration of a machine learning-based future innovation prediction system according to an embodiment of the present invention.

### BEST MODE

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated features, integers, steps, operations, elements, parts or combinations thereof, but do not preclude the presence or addition of steps, operations, elements, parts, or combinations thereof.

Unless defined otherwise, all terms (including technical and scientific terms) used herein have the same meanings as commonly understood by one of ordinary skill in the art to which this invention belongs. Further, unless explicitly defined to the contrary, the terms defined in a generally-used dictionary are not ideally or excessively interpreted.

Hereinafter, preferred embodiments of the inventive concept will be described in detail with reference to the accompanying drawings. The same reference numerals are used for the same components in the drawings, and duplicate descriptions of the same components are omitted.

Embodiments of the present invention may investigate future innovation predictors in terms of a company based on large data sets related to the company's finances, R&D, newspaper articles, and patents for a predetermined period, for example, from 1991 to 2010, by applying machine learning techniques. Specifically, the present invention may predict whether or not the company successfully presents/launches innovative technologies/products/services using information about the company's finances, newspaper articles, and patents. The present invention may predict future innovation by the company using five machine learning techniques, for example, the logistic regression (Logit) as a basic model, the naive Bayes (NB), the neural network (NN), the support vector machine (SVM), the deep belief network (DBN).

Previous studies on the firm use of information systems research cover a variety of topics, but are mainly classified into two stages: how information technology is adopted by companies and their impact on the performance of companies. The first research stream is to examine the processes and the underlying mechanism for adopting information technology in a company. An example is the adoption of health information technology systems by hospitals in the United States. Previous research in the second stream has focused on three aspects: profitability, organizational agility and innovation.

In particular, previous studies on information system researches have emphasized the important role of information technology for firm innovation which is a company's ability to identify, assimilate, transform, and apply valuable external knowledge for the company's business success, such as the development and maintenance of absorptive capacities of the company. It also improves customer agility to seize opportunities for customer base innovation and competitive action. In particular, information processing capabilities such as big data analysis results in competitive advantage in organizations, and the power of predictive data analysis helps decision-making. At the same time, the innovation literature also shows that accessing and integrating knowledge from sources residing outside the company, such as customers, competitors, universities, and consultants, is critical to a company's innovative success. However, previous studies on information system researches have not yet considered a method of applying predictive analysis for firm innovation using knowledge from various sources, such as patent information.

In terms of types of analytical approaches, previous studies can perform descriptive, predictive or normative classification. In particular, the predictive approach discovers descriptive and predictive patterns that reveal the intrinsic relationship between the causes and effects of innovation by using data and mathematical techniques. The predictive approach raises two different questions: “Why would that happen?” and “what will happen?”. The former seeks to uncover the causal relationship of radical innovation at various levels of analysis, such as financial input and innovation, while the latter seeks to accurately predict future events.

Most previous studies on innovation focus on the causal relationship of innovation by empirically adopting statistical methods to discover the driving factors of radical innovations. However, it is difficult to find studies focusing on accurate prediction of innovation in the future, especially at the company level. The reason for this is that it is difficult to evaluate innovations, and the development of innovations is unpredictable and sporadic. Because of the technical uncertainty caused by the uneven zigzag of scientific breakthroughs, it usually takes five to six years to realize whether it is innovative or not. Moreover, although it appears after decades of rigorous research and a profound understanding of unmet customer needs, it may not lead to success in the market or business.

Nevertheless, the importance of predicting future radical innovations should be emphasized as companies can allocate resources more effectively while focusing on higher innovations and enhancing their competitive advantage. Investors can also manage their investment portfolios more effectively while overcoming the uncertainty of exploratory investing. In general, companies that are better able to cope with the unpredictability of innovation tend to do better than those that are less.

To solve this, the present invention proposes a research framework for discovering predictors of future innovation at the company level. In the framework of the present invention, patent-based indicators are used as features with the potential to predict future innovations, in contrast to other measures in previous studies, unlike surveys that rely on the knowledge and experience of managers or CEOs. In addition, techniques based on machine learning can be adopted as an alternative to statistical methods commonly used in most previous studies on innovation.

In this context, the present invention can explore the usefulness of examining potential predictors and predicting future innovation among the features of information about a company's finances, newspaper articles, and patents. Potential financial information may include the amount of R&D investment of a company, the amount of assets of the company, the amount of liabilities of the company, the amount of profit and loss of the company, and the like, potential newspaper articles and social media information about the company may include the number of newspaper articles and social media content mentioning the company, newspaper articles and social media content, and structural associations between newspaper articles and social media, and potential patent indicators may be classified into four features: (1) basic, (2) collaboration-related, (3) citation, and (4) patent content. The basic features include the number of patents and claims, the technical field and applied products of the patent, the reason for rejection of each patent, the content of the patent, and the like, and collaboration-related features include the number of assignees and the number of inventors. Also, the structural properties of collaboration between the assignee and the inventor. Features related to citations include the number of backward and forward citations and the structural nature of the backward citations. Features related to patent content include properties related to similarity and relationship in patent content between patents and technology classification.

When describing the collaboration-related features, collaboration between different actors is increasingly being more important in R&D and product or technological innovation as well as knowledge generation in science, because one person alone has little or no ability to keep pace with scientific and technological progress. The impact of collaboration on innovation has been studied from two perspectives: internal collaboration and external collaboration. Thus, the present invention may involve both internal and external collaborations to investigate innovation's usefulness in predicting the innovation.

Although there is growing consensus that the network structure of collaboration is an important driving factor for innovative performance, the usefulness of predicting future innovation of a company is still unknown. To clarify it, the properties of internal and external collaboration structures may be considered as potential predictors in the present invention.

Moreover, since patent citations are characterized by a complex, expansive, and distributed knowledge base, an appropriate level of patent citation analysis for innovation is the overall patent citation structure analysis. The structure and position of patents in the citation structure analysis (e.g., centrality index, etc.), determine access to relevant knowledge sources, and they have consequences for innovation activity and performance at the company level. In particular, it is possible to provide an opportunity to look into the patent relationship from a three-dimensional point of view through the backward patent citation structure and to extract structural patent indicators.

Machine learning techniques learn a model from existing data and make predictions on new data using the model. Machine learning techniques have been used as powerful alternatives to statistical methods for classifying and predicting patterns while dealing with large, noisy, and complex data. Recently, the implementation of machine learning for prediction appears in various fields such as biomedical informatics, text/web mining, computer vision, business, civil engineering, and games.

Previous studies of an embodiment have applied a machine learning technique to patent materials for the purpose of prediction, and the present invention may use a machine learning technique to predict future innovation. In the present invention, commonly used machine learning techniques, that is, NB, NN, and SVM may be selected.

NB is a fairly simple probabilistic classification algorithm, which uses strong independent assumptions for various features. NB assumes that the true distribution of data is a convex combination of individual distributions in which the features of data are conditionally independent. The aim is to learn the weights of combination and feature as limits within each distribution using the training data, and many NB models, such as polynomial naive Bayes model, Poisson naive Bayes model, and binary independence model, have been proposed. For classification, NB predicts the probability of a specific instance belonging to a specific class. It first calculates the probability of unclassified data belonging to each class, and then performs classification it with high probability. NBs often outperform more sophisticated classifiers on many data sets because NBs enable efficient building of classification models.

NN is based on the nervous system of an organism, such as neurons, to mimic the accumulation of knowledge in the biological central nervous system. Unlike conventional computer-based techniques, NN can solve non-linear and poorly-defined problems based on parallel configurations. Because of this unique learning ability, NNs have achieved good results in popular and diverse applications. Neural networks are of two types: single-layer NNs and multi-layer NNs. A single-layer NN consists of an input layer and an output layer, whereas a multi-layer NN consists of three layers: an input layer, a hidden layer, and an output layer. In the case of multi-layer NN, the input layer passes the input value to the hidden layer, and then the hidden layer determines an appropriate weight for deduction of the optimal output value, verifies it and assigns the final output value. The weight values of the NN are determined through a continuous learning procedure, and backpropagation is commonly used to determine the weight values.

SVM is based on the principle of structural risk minimization of computer learning theory. For classification, SVM classifies the data points as accurately as possible by minimizing the risk of misclassification of the training sample and the invisible test sample, and finds the optimal separation hyperplane that separates the points of the two classes as much as possible. The training point closest to the optimal separation hyperplane is called a support vector, and other training cases are independent of determining binary class boundaries. For SVM, the kernel is used to implicitly map the input space X to the high-dimensional feature space F. The computation of the learning machine may be improved by creating a non-linear decision-making surface. Moreover, it helps to potentially decompose a linearly inseparable space into a linearly separable space.

Finally, deep learning refers to an artificial neural network that includes multiple layers of information processing units hierarchically. For example, modern machine learning algorithms have serious problems in that they are inefficient in terms of the number of computational units, but such problems can be solved by condensedly expressing a large number of non-linearities, that is, to a wide variety of functions through deep architectures. Among the various types of deep learning architectures, DBN is widely used in applications where input data can be represented as a fixed set of features, such as image processing and speech recognition. DBN has multiple layers, consisting of a visible layer and one or more hidden layers. The visible layer of the DBN takes features as input data and passes the input data to a hidden layer built as a stack of one or more constrained Boltzmann machines (RBMs).

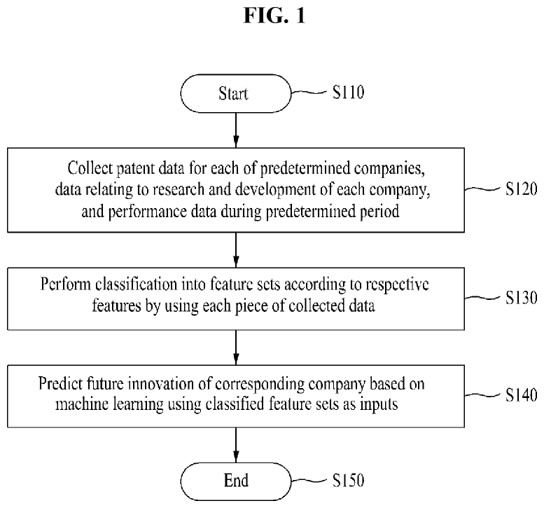

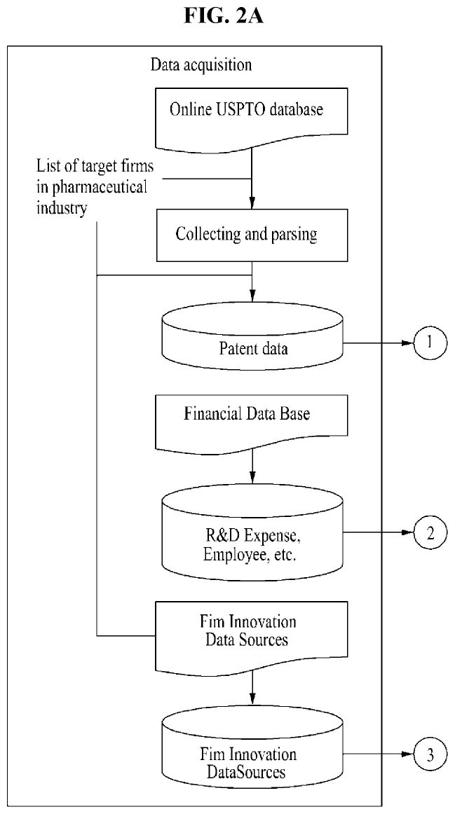

FIG. 1 illustrates an operational flowchart a machine learning-based future innovation prediction method according to an embodiment of the present invention.

Referring to FIG. 1, the method according to the present invention may include collecting patent data for each of predetermined companies, data relating to research and development of each of the companies, and performance data during a predetermined period (S110), performing classification into feature sets according to features by using each piece of the collected data (S120), and predicting future innovation of a corresponding company on the basis of machine learning using the classified feature sets as inputs (S130).

Here, step S110 is to, for each of the companies for a preset period, collect company financial information including the company's R&D investment amount, the company's assets, the company's liabilities, the company's profit and loss, or the like, collect newspaper article and social media information about the company including the number of newspaper articles and pieces of social media content mentioning the company, newspaper article and social media content, and structural associations between newspaper articles and social media, collect patent data for each of the registered patents including the number of claims, assignees, the number of assignees, inventors, the number of inventors, the number of backward and forward citations and the structural relationship between patents by analysis of patent content, and collect the company's future innovations such as passing clinical trials for a certain period of time, data approved by the U.S. Food and Drug Administration (FDA), technical and commercial success data of technology, and launch/certification/authorization data of new products/new services data.

Here, step S120 is to perform classification into feature sets, including financial indicators of a company and their structural variables; articles and social media content about the company and their structural variables; internal and external collaboration structures using patent indicators using patent data and data related to R&D and relationship between patents based on analysis of patent content.

Here, step S130 may predict the performance of a corresponding company based on machine learning using logistic regression (Logit), naive Bayes (NB), neural network (NN), support vector machine (SVM) and deep belief network (DBN).

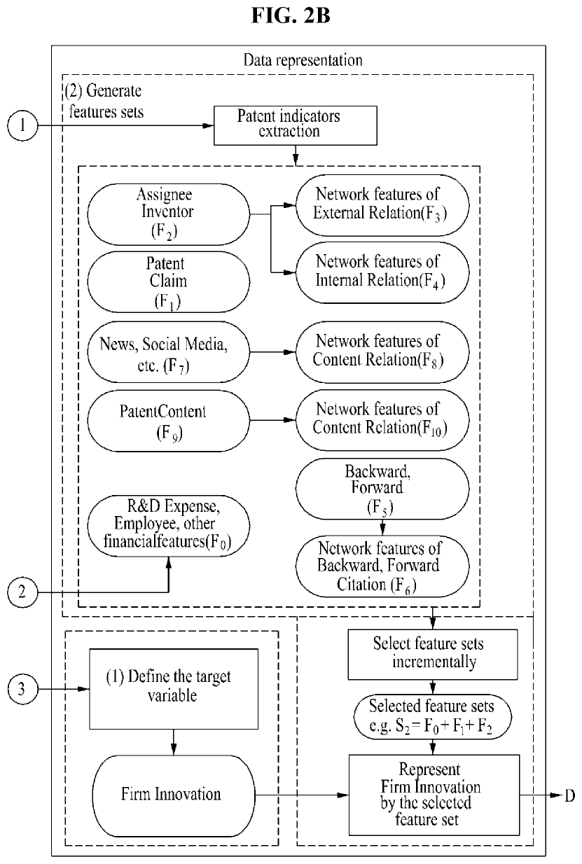

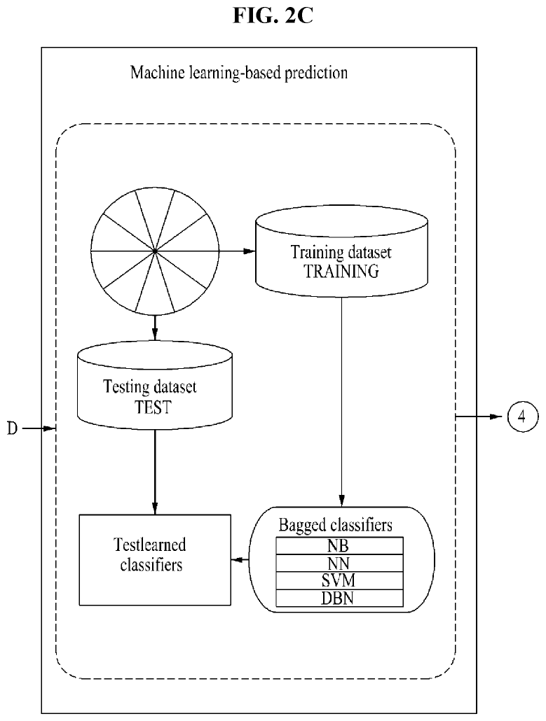

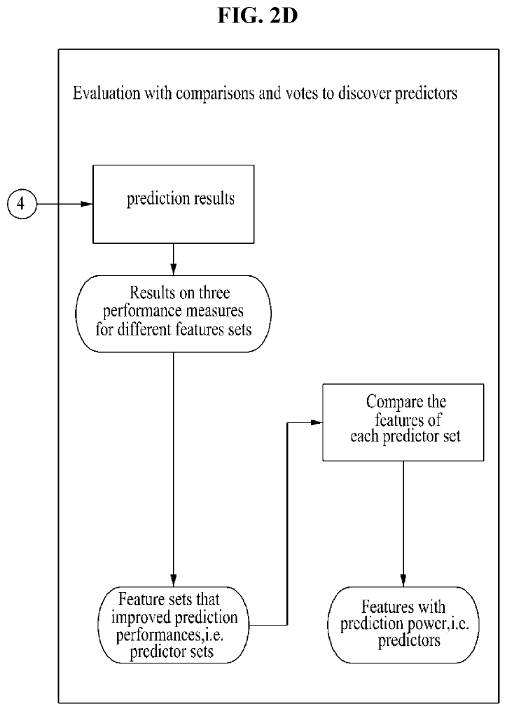

The method of the present invention will be described below in detail with reference to FIG. 2A, 2B, 2C and 2D.

FIG. 2A, 2B, 2C and 2D illustrates a framework for a machine learning-based future innovation prediction method according to an embodiment of the present invention.

Referring to FIG. 2A, 2B, 2C and 2D, the method according to an embodiment of the present invention may classify patent indicators investigated from previous innovation studies into feature sets. For the prediction method, five machine learning classification methods such as Logit, NB, NN, SVM, and DBN may be adopted. For each classification method, the effects of subsequently adding feature sets may be evaluated through tenfold validation in terms of three performance measures: accuracy, F-measure, and area under the curve (AUC). In addition, the present invention may perform a two-way “t” test on the performance scale based on repeated experiments to determine the statistical significance of the tenfold validation. In the case of feature sets found to be useful for prediction, in-depth comparison is performed to determine which of the feature sets improves prediction performance. Configurations will be sequentially described as follows.

Data Acquisition

The present invention may collect the financial data, newspaper article data, social media data, patent data, and the like of a company and configure the integrated data sets thereof.

For example, the present invention may collect patent-related independent variables using a United States Patent and Trademark Office (USPTO) database for predetermined companies, collect financial data using a financial-related database, and collect firm innovation data sources using the firm innovation data sources.

Data Representation

(1) Definition of Target Variables

Firm innovation can be defined as the technological and commercial success of a company's technology, the launch/certification/permission of new products/new services, and in the case of pharmaceutical companies, the passing of clinical trials, and approval by the U.S. Food and Drug Administration (FDA).

(2) Generation of Feature Sets

The collected financial data, newspaper article data, social media data, and patent data of a company may be used to construct feature sets that provide descriptive statistics for related indicators.

In order to explore the usefulness of each feature set for improving measurement of performance, another feature set in year “t” can be used as an input variable to predict innovation in year (t+1).

Here, the feature set may be one of F0 to F10, as shown in FIG. 2A, 2B, 2C and 2D.

Machine Learning-Based Prediction of Future Innovation

The variable xi represents the i-th instance in experimental data, and xi,j represents the value of the j-th feature of the i-th instance.

Use of Naive Bayes as a Weak Classifier

The NB classification process consists of two steps: training and testing. In the training phase, the prior distribution of features is implicitly or explicitly assumed to be a Dirichlet distribution. Next, in the testing phase, the classifier may identify all possibilities of each class to which one test data belongs, and then set a class with the maximum probability for the test data. The issue of the present invention using NB can be expressed as in Equation 1 below.

ŷᵢ=argmax_{y}_{ᵢ}_{∈{+1,-1}}P(yᵢ|xᵢ) [Equation 1]

From a probabilistic point of view, according to the Bayes rule, when xi is given, the probability that class yi ∈ {+1,−1} is obtained may be expressed as in Equation 2 below.

$$P ( {y}_{i} \vert {x}_{i} ) = \frac{P ( {y}_{i} ) P ( {x}_{i} \vert {y}_{i} )}{P ( {x}_{i} )} \qquad [ Equation 2 ]$$

In Equation 2, the probability distribution xi,j of the continuous value given the class yi may be defined as in Equation 3 below.

$$p ( {y}_{i} \vert {x}_{i} ) = \frac{1}{\sqrt{π {σ}_{{y}_{i}}^{2}}} {e}^{- \frac{{( {x}_{i , j} - {μ}_{y i} )}^{2}}{2 {σ}_{{y}_{i}}^{2}}} \qquad [ Equation 3 ]$$

In Equation 3, μ_{yi} and σ²_{yi} represents the mean and variance of xi,j associated with class yi.

NB may use probability calculation simplified under assumption that all features are independent according to the values of class variables as shown in <Equation 4> and <Equation 5> below.

$$P ( {y}_{i} \vert {x}_{i} ) = {\prod }_{j = ′}^{d} p ( {x}_{i , j} \vert {y}_{l} ) \qquad [ Equation 4 ]$$

$$p ( {y}_{i} \vert {x}_{i} ) = \frac{P ( {y}_{i} ) = {\prod }_{j = 1}^{d} p ( {x}_{i , j} \vert {y}_{i} )}{{\sum }_{i = 1}^{{n}^{′}} P ( {y}_{i} ) {\prod }_{j = 1}^{d} p ( {x}_{i , j} \vert {y}_{i} )} \qquad [ Equation 5 ]$$

where n′ represents the number of instances in Bm. Accordingly, Equation 1 can be expressed as Equation 6 below.

$${\hat{y}}_{i} = argmax [ \frac{P ( {y}_{i} ) = {\prod }_{j = 1}^{d} p ( {x}_{i , j} \vert {y}_{i} )}{{\sum }_{i = 1}^{{n}^{′}} P ( {y}_{i} ) {\prod }_{j = 1}^{d} p ( {x}_{i , j} \vert {y}_{i} )} ] \qquad [ Equation 6 ]$$

Since the common denominator can be omitted in Equation 6, without affecting the classification result, Equation 6 can be expressed as in Equation 7 below.

$${\hat{y}}_{i} = {argmax}_{{y}_{i} ϵ \{ + 1 , - 1 \}} [ P ( {y}_{i} ) {\prod }_{j = 1}^{d} p ( {x}_{i , j} \vert {y}_{i} ) ] \qquad [ Equation 7 ]$$

Therefore, when (P(yᵢ=+1|xᵢ>P(yᵢ=−1/xᵢ)), y\hat{ }₁=+1 can be obtained. Otherwise, the NB classifier may be defined as in Equation 8 below.

$$q ( {x}_{i} ) = \frac{p ( {y}_{i} = + 1 )}{p ( {y}_{i} = - 1 )} {\prod }_{i = 1}^{{n}^{′}} \frac{p ( {x}_{i} \vert {y}_{i} = + 1 )}{p ( {x}_{i} \vert {y}_{i} = - 1 )} \qquad [ Equation 8 ]$$

In TRAINING, instance xi ∈ TEST is classified as class+1 by NB when q(xi)>1.

Use of a neural network as a weak classifier

Based on previous studies using the NN model, in the present invention, the three-layer perceptron may be used as the NN model. In this case, the output value of the three-layer perceptron may be formulated as in Equation 9 below.

$${y}_{i} = {f}_{3} ( {\sum }_{k = 1}^{{N}_{hidden}} {w}_{k , 3} {h}_{k} - θ ) \qquad [ Equation 9 ]$$

where N_{hidden} represents the number of neurons in the hidden layer, w_{k,3} represents the weight of the synapse from the neuron k in the hidden layer to an output neuron, hk represents the output of the neuron k, θ represents the threshold of the output neuron, and f3 represents a sigmoid (S-shaped) activation function of the output neuron.

The output value of the neuron k in the hidden layer may be expressed as in Equation 10 below.

$${h}_{κ} = {f}_{2} ( {\sum }_{h = 1}^{d} {w}_{j , k} {x}_{i , j} - θ ) \qquad [ Equation 10 ]$$

where w_{j,k} represents the weight from the input neuron (j=1, . . . , d) to the k-th neuron in the hidden layer, θₖ represents the threshold of the k-th neuron, and f2 represents the sigmoid activation function of the hidden neuron.

In the training phase, the backpropagation algorithm may iteratively update the weight and threshold of each training vector xi ∈ TRAINING based on gradient descent as shown in Equation 11 and Equation 12 below.

$$Δ {w}_{j , k}^{i} ( r ) = - a \frac{{dE}^{i} ( r )}{{dw}_{j , k}^{i} ( r )} \qquad [ Equation 11 ]$$

$${Δθ}_{j , k}^{i} ( r ) = - a \frac{{dE}^{i} ( r )}{{dw}_{j , k}^{i} ( r )} \qquad [ Equation 12 ]$$

where “a” represents a learning rate, and Ei(r) represents the sum of the squared errors (SSEs) for the repetition r of xi, and Eⁱ(r) may be expressed as in Equation 13 below.

$${E}^{i} ( r ) = \frac{1}{2} {( {o}_{i} ( r ) - y ( r ) )}^{2} \qquad [ Equation 13 ]$$

where oᵢ(r) represents an actual output value. Finding the minimum SSE may be repeatedly performed until the gradient descent approach of 0 is reached. Then, the instance xi ∈ TEST may be classified into one of two classes, +1 and −1, by trained NN.

Use of a support vector machine as a weak classifier

SVM may project data into a higher-dimensional feature space, wTx+b=0 by using a kernel and find a linear margin in the maximal margin hyperplane (MMH) which is a new feature space. Based on the previous research, an optimization formula to solve the weight vector w=(w1, . . . , wd)T and the scalar b of the new feature space may be expressed as Equation 14 below.

$$min \frac{1}{2} 〈 w , w 〉 + {\sum }_{j = 1}^{{n}^{′}} {c}_{yi} {ξ}_{i} \qquad [ Equation 14 ]$$

$$s . t . {y}_{i} ( 〈 w , φ ( {x}_{i} ) 〉 b ) \geq 1 - {ξ}_{j} and {ξ}_{i} \geq 0$$

In this case, the following expressions may be used.

Parameters c+1 and c−1 are a trade-off between the empirical error and the generalization <w,w> and n′ is the number of instances of Bm.

The first term in Equation 14 represents the complexity of the classification function, while the second term measures the empirical error for Bm.

The optimal hyperplane that identify class +1 and class −1 may be expressed as in Equation 15 below.

$$g ( x ) = {\sum }_{j = 1}^{{n}^{′}} {y}_{i} {α}_{j} K ( {x}_{i} , x ) + b \qquad [ Equation 15 ]$$

where K(xi,x)=φ(xi)Tφ(x), and in the present invention, K(xi,x) may be treated as a polynomial kernel of grade=5, and it may be expressed as the following <Equation 16>.

K(xᵢ,)=(xᵢ^{T}x+1)⁵ [Equation 16]

Therefore, the trained SVM classifier may add an instance ix ∈ TEST to the +1 class group when g(xi)>1, and otherwise, add an instance to the −1 class group.

Use of a Deep Trust Network as a Weak Classifier

DBN consists of one visible layer and one or more hidden layers, and each layer may be initialized by the RBM. RBM is a non-directional generative energy-based model with a visible input layer and a hidden layer, with links between layers but no links within layers. According to previous research, DBN with l layers may model the joint distribution of xi and l hidden layers hk as shown in Equation 17 below.

$$P ( {x}_{i} , {h}^{i} , … , {h}^{i} ) = ( {\prod }_{j = 0}^{1 - 2} P ( {h}^{*} \vert {h}^{k + 1} ) ) P ( {h}^{i - 1} , {h}^{l} ) \qquad [ Equation 17 ]$$

where xᵢ=h⁰, P(h^{k-1}, h^{k}) is the conditional distribution for the visible units conditioned on the hidden units of the RBM at level k, and P(h^{l-1}, hl) is the visible-hidden joint distribution of the top-level RBM. Training of DBN includes two stages including a pre-training stage and a fine-tuning stage for each layer.

First, the pre-training stage for each layer may train the RBN parameters through two stages of contrastive divergence (CD) procedure. In the first stage, training is executed to model the first layer as the RBM and the raw input xi=h⁰ as its visible layer. The first layer is used to obtain a representation of the input to be used as the data of the second layer. The sigmoid activation function may be used for expression. Next, in the second stage, the second layer is trained by the RBN by using the transformed data as a training case for the visible layer of the corresponding RBM. As a result, the link weights between the layer and the node deviation of the RBM are trained. These two phases are repeatedly performed until the maximum number of iterations for the layer is reached.

Next, in the fine-tuning stage, all parameters of the deep architecture of DBN are fine-tuned using supervised gradient descent. A logistic regression classifier is used to classify the input xi based on the output of the last hidden layer hl of the DBN.

After the training stage, by using

$${\hat{y}}_{i} = {argmax}_{{y}_{i} ϵ \{ + 1 , - 1 \}} [ P ( {y}_{i} \vert {x}_{i} ) ]$$

as the output of DBN using all parameters obtained in the stage of training the DBN with Bm from TRAINING, the instance ix ∈ TEST is classified as +1 or −1, and is obtained from the last logistic regression output layer of of the DBN.

Evaluation by Comparison and Vote to Find Predictors.

In this stage, the usefulness of adding different function sets may be measured through three performance measurements after the tenfold verification. For each of the five classification techniques, a feature set with improved prediction performance in a statistically significant manner may be generated. Based on these results, if all five classification techniques determine that adding of a feature set contributes to improving the prediction performance, the feature set can be considered as being useful as a predictor set. Next, for each set of predictors with two or more features, it is possible to determine which features of the set of predictors lead to better prediction performance by performing in-depth comparison through a pairwise t-test. Therefore, if more than half of the five classification techniques have determined that a feature have improved prediction performance through three performance measures, the feature may be selected as a patent index with reliable predictive power for future innovation, that is, a prediction factor.

As described above, the method according to an embodiment of the present invention may add at least one or more of structural variables regarding the relationship between a corresponding company and other companies, news/press releases of the company and other companies, and social media, structural variables regarding the inventors, structural parameters regarding applicants and structural variables for relations between registered patents and predict future innovation of the corresponding company using the added set of features.

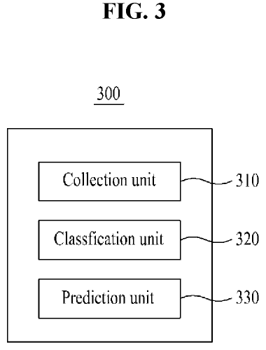

FIG. 3 shows a configuration of a machine learning-based future innovation prediction system according to an embodiment of the present invention, and shows a conceptual configuration for a system performing the method of FIGS. 1 to 2.

Referring to FIG. 3, a system 300 according to an embodiment of the present invention includes a collection unit 310, a classification unit 320 and a prediction unit 330.

The collection unit 310 may collect patent data for each of predetermined companies, data relating to research and development of each of the companies and performance data during a predetermined period.

In this case, the collection unit 310 may, for each of the companies, collect company financial information including the company's R&D investment amount for a preset period, the company's assets, the company's liabilities, the company's profit and loss, or the like, collect newspaper article and social media information about the company including the number of newspaper articles and pieces of social media content mentioning the company, newspaper article and social media content, and structural associations between newspaper articles and social media, collect patent data for each of the registered patents including the number of claims, assignees, the number of assignees, inventors, the number of inventors, the number of backward and forward citations and patent content, and collect the company's future innovations such as passing clinical trials for a certain period of time, data approved by the U.S. Food and Drug Administration (FDA), technical and commercial success data of technology, and launch/certification/authorization data of new products/new services data.

The classification unit 320 may perform classification into feature sets according to features using each piece of the collected data.

In this case, the classification unit 320 may perform classification into feature sets, including financial indicators of a company and their structural variables, articles and social media content about the company and their structural variables; internal and external collaboration structures using indicators using patent data and related data and relationship between pieces of patent content.

The prediction unit 330 may predict the innovation of a corresponding company based on machine learning to which the classified feature sets are input.

In this case, the prediction unit 330 may predict the performance of a corresponding company based on machine learning using logistic regression (Logit), naive Bayes (NB), neural network (NN), support vector machine (SVM) and deep belief network (DBN).

Although the description is omitted with reference to the apparatus of FIG. 3, components constituting FIG. 3 may include all the contents described with reference to FIGS. 1 to 2, which are obvious to those skilled in the art.

The apparatus described herein may be implemented with hardware components and software components and/or a combination of the hardware components and the software components. For example, the apparatus and components described in the embodiments may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of executing and responding to instructions. The processing device may run an operating system (OS) and one or more software applications that run on the OS. The processing device also may access, store, manipulate, process, and create data in response to execution of the software. For convenience of understanding, one processing device is described as being used, but those skilled in the art will appreciate that the processing device includes a plurality of processing elements and/or multiple types of processing elements. For example, the processing device may include multiple processors or a single processor and a single controller. In addition, different processing configurations are possible, such a parallel processors.

The software may include a computer program, a piece of code, an instruction, or some combination thereof, for independently or collectively instructing or configuring the processing device to operate as desired. Software and/or data may be embodied in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described methods may be embodied in the form of program instructions that can be executed by various computer means and recorded on a computer-readable medium. The computer readable medium may include program instructions, data files, data structures, and the like, alone or in combination. Program instructions recorded on the media may be those specially designed and constructed for the purposes of the inventive concept, or they may be of the kind well-known and available to those having skill in the computer software arts. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that can be executed by a computer using an interpreter or the like.

Although the embodiments have been described by the limited embodiments and the drawings as described above, various modifications and variations are possible to those skilled in the art from the above description. For example, the described techniques may be performed in a different order than the described method, and/or components of the described systems, structures, devices, circuits, etc. may be combined or combined in a different form than the described method, or other components, or even when replaced or substituted by equivalents, an appropriate result can be achieved.

Therefore, other implementations, other embodiments, and equivalents to the claims are within the scope of the following claims.

1. A machine leaning-based future innovation prediction method comprising:
collecting patent data for each of predetermined companies, data relating to research and development of each of the companies, and performance data during a predetermined period;
performing classification into feature sets according to respective features by using each piece of the collected data; and
predicting future innovation of a corresponding company on the basis of machine learning using the classified feature sets as inputs.

2. The machine learning-based future innovation prediction method of claim 1, wherein the collecting of the data includes
collecting patent data including a number of claims, an assignee, a number of assignees, an inventor, a number of inventors, a number of backward citations, and a number of forward citations for each of registered patents during the predetermined period with respect to each of the companies.

3. The machine learning-based future innovation prediction method of claim 2, wherein the collecting of the data includes collecting data for each of the companies including company finances for the predetermined period, pass of clinical trials, data approved by the U.S. Food and Drug Administration (FDA), technical and commercial success data of technology, and launch/certification/authorization data of new products/new services, as performance data.

4. The machine learning-based future innovation prediction method of claim 1, wherein the predicting of the future innovation includes predicting the performance of a corresponding company based on machine learning using logistic regression (Logit), naive Bayes (NB), neural network (NN), support vector machine (SVM) and deep belief network (DBN).

5. The machine learning-based fixture innovation prediction method of claim 1, wherein the performing classification includes performing classification into feature sets including internal and external collaboration structures using patent indicators using the patent data and the data relating to research and development and structural relationships between patents based on analysis of patent content.

6. A machine learning-based future innovation prediction system comprising:
a collection unit configured to collecting patent data for each of predetermined companies, data relating to research and development of each of the companies, and performance data during a predetermined period;
a classification unit configured to perform classification into feature sets according to respective features by using each piece of the collected data; and
a prediction unit configured to predict future innovation of a corresponding company on the basis of machine learning using the classified feature sets as inputs.

7. The machine learning-based future innovation prediction system of claim 6, wherein the collection unit is configured to collect patent data including a number of claims an assignee, a number of assignees, an inventor, a number of inventors, a number of backward citations, and a number of forward citations for each of registered patents during the predetermined period with respect to each of the companies.

8. The machine learning-based future innovation prediction system of claim 7, wherein the collection unit is configured to collect data for each of the companies including company finances for the predetermined period, pass of clinical trials, data approved by the U.S. Food and Drug Administration (FDA), technical and commercial success data of technology, and launch/certification/authorization data of new products/new services, as performance data.

9. The machine learning-based future innovation prediction system of claim 6, wherein the prediction unit is configured to predict the performance of a corresponding company based on machine learning using logistic regression (Logit), naive Bayes (NB), neural network (NN), support vector machine (SVM) and deep belief network (DBN).

10. The machine learning-based future innovation prediction system of claim 6, the classification unit is configured to perform classification into feature sets including internal and external collaboration structures using patent indicators using the patent data and the data relating to research and development and structural relationships between patents based on analysis of patent content.
